(19) United States
(12) Patent Application Publication
(10) Pub. No.: US 2026/0167119 A1
(43) Pub. Date: Jun. 18, 2026

(54) DISPLAY DEVICE

(71) Applicant: Nippon Seiki Co., Ltd., Niigata (JP)

(72) Inventors: Koji Tooyama, Niigata (JP); Yuichi Fukumitsu, Niigata (JP)

(21) Appl. No.: 19/397,101

(22) Filed: Nov. 21, 2025

(30) Foreign Application Priority Data
Dec. 17, 2024 (JP) 2024-220688

(51) Int. Cl. B60R 11/02; B60K 35/22; B60R 11/00

(52) U.S. Cl. CPC B60R 11/0235; B60K 35/22; B60R 2011/0005; B60R 2011/0052

(57) ABSTRACT

A display device that can prevent interference with a vehicle body and ensure a sufficient strength of the attachment stay is provided. A display device includes a display portion that displays information, and a case member housing the display portion. The case member includes an attachment portion protruding outward from an outer wall. The display device is to be installed in a vehicle by fixing the attachment portion to the vehicle. The case member includes a reinforcing portion and the reinforcing portion includes a protruding piece protruding inward from the outer wall and a rib portion extending across the outer wall and the protruding piece. The reinforcing portion is formed in a position facing the attachment portion.

### TECHNICAL FIELD

The present invention relates to a display device to be installed on a vehicle such as an automobile.

### BACKGROUND ART

A conventional display device is disclosed in, for example, Patent Document 1. This display device includes a display unit, a circuit board disposed rearward of the display unit, an inner case disposed on the circuit board, a facing that covers the front side of the display unit and the inner case, and a lens that covers the front side of the facing, and displays various information as images on the display surface of the display unit. The display device also includes an attachment stay protruding from a lower case, and the display device is installed in an instrument panel of a vehicle, by fixing the attachment stay to the instrument panel of a vehicle body, with screws.

### PRIOR ART DOCUMENT

### Patent Document

Patent Document 1: Japanese Unexamined Patent Application Publication No. 2023-131800.

### SUMMARY OF INVENTION

### Technical Problem

To prevent such an attachment stay from breaking, a rib extending across the attachment stay and the lower case may be provided. However, providing a rib in such a manner may be problematic, because the rib may interfere with the instrument panel.

The present disclosure has been made in consideration of the above-described circumstances, and an object thereof is to provide a display device that can prevent interference with a vehicle body and ensure a sufficient strength of the attachment stay.

### Solution to Problem

To solve the above-mentioned problems, a display device 100 according to the present invention includes a display portion 90 that displays information, and a case member 60 housing the display portion 90, the case member 60 includes an attachment portion 64 protruding outward from an outer wall 61, 62, the display device 100 is to be installed in a vehicle by fixing the attachment portion 64 to the vehicle, the case member 60 includes a reinforcing portion 65 and the reinforcing portion 65 includes a protruding piece 66 protruding inward from the outer wall 61, 62 and a rib portion 67 extending across the outer wall 61, 62 and the protruding piece 66, and the reinforcing portion 65 is formed in a position facing the attachment portion 64.

### BRIEF DESCRIPTION OF DRAWINGS

FIG. 1 is a front view of a display device which is a first embodiment of a display device according to the present disclosure.

FIG. 2 is a cross-sectional view taken along a line A-A in FIG. 1.

FIG. 3 is a view illustrating a lower case, as viewed in a direction of an arrow B in FIG. 2.

FIG. 4 is a diagram illustrating a second embodiment of the display device according to the present disclosure.

FIG. 5 is a diagram illustrating a third embodiment of the display device according to the present disclosure.

FIG. 6 is a diagram illustrating a fourth embodiment of the display device according to the present disclosure.

FIG. 7 is a diagram illustrating a fifth embodiment of the display device according to the present disclosure.

FIG. 8 is a diagram illustrating a sixth embodiment of the display device according to the present disclosure.

### DESCRIPTION OF EMBODIMENTS

An embodiment of a display device according to the present disclosure will be described with reference to the accompanying drawings. The display device according to the present disclosure is to be installed on vehicles such as automobiles and motorcycles, ships, agricultural machinery, and construction machinery, for example. In the present embodiment, the display device of the present disclosure will be described using, as an example, a display device to be installed in an instrument panel 200 of a vehicle as an object to which the display device is attached.

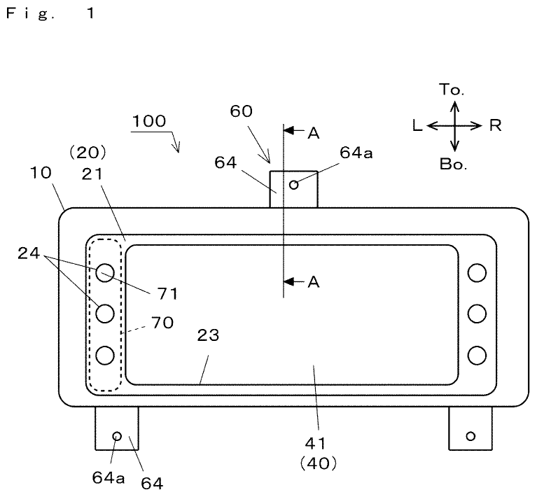

In the following description, “front (front side)”, “rear (back side)”, “upper”, “lower”, “right”, and “left” is in accordance with the definitions of “Fr.”, “Re.”, “To.”, “Bo.”, “R”, and “L” in FIGS. 1 to 3. Note that a side on which the display device 100 is visually recognized by the user is referred to as the “front”.

### First Embodiment

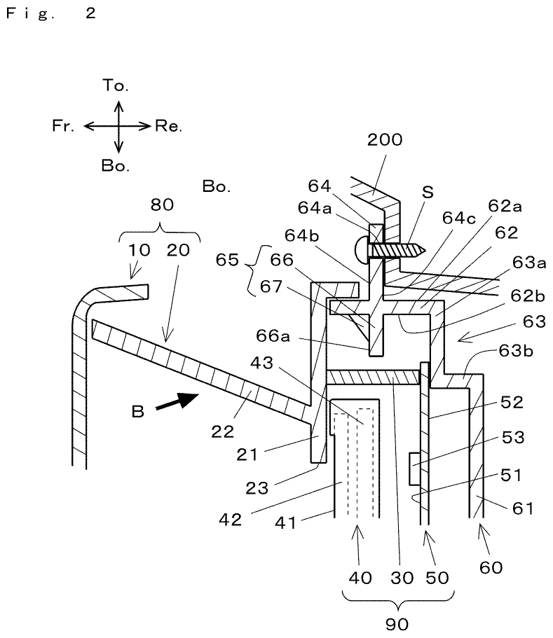

The display device 100 is installed in the instrument panel 200 of the vehicle and displays various information (for example, a speedometer, a tachometer, a remaining fuel gauge, a thermometer, an odometer, etc.) which are visually recognized by the driver. As illustrated in FIGS. 1 and 2, in the display device 100, a display portion 90 is housed inside a housing formed by a cover portion 80 on the front side and a lower case on the rear side (a case member) 60. The cover portion 80 is formed by a facing 20 and a lens 10 that covers the front side of the facing 20. The display portion 90 includes a display unit 40 having a display surface 41 on the front side, a circuit board 50 disposed rearward of the display unit 40, and an inner case 30 covering the display unit 40 and disposed forward of the circuit board 50. The display portion 90 is mainly housed in the lower case 60.

The lens 10 is made of a light-transmitting inorganic glass or resin (for example, polymethyl methacrylate resin (PMMA)). The lens 10 is attached to the facing 20 from the front via a hook or the like, and covers the front side of the facing 20. The lens 10 protects the inside of the cover portion 80 against dust and the like.

The facing 20 is made of a light-blocking synthetic resin (for example, a polypropylene resin) having a black color, for example. The facing 20 is attached to the lower case 60 on the rear side, from the front via a hook or the like. The facing 20 includes a front portion 21 and a raised wall portion 22.

The front portion 21 is generally formed in a box shape with an open rear end, and covers the front side of the lower case 60. The front portion 21 includes a display opening portion 23 and an indicator opening portions 24. The display opening portion 23 is a rectangular hole opened at a location to face the display surface 41 of the display unit 40. The indicator opening portions 24 are holes formed at locations to face a plurality of design portions 71 of an indication plate 70 described later. The raised wall portion 22 is formed in a substantially tubular shape to surround the display opening portion 23 and the indicator opening portions 24.

The display unit 40 is a display that displays various information as images on the display surface 41. The display unit 40 includes four circular columnar boss portions protruding toward the circuit board 50, and is fixed to the circuit board 50 by screws inserted into these boss portions from the read side of the circuit board 50. The display unit 40 includes a display panel 42 and a backlight unit 43.

The display panel 42 is, for example, a Thin Film Transistor (TFT) type liquid crystal display panel. The display panel 42 is a large panel, for example, having a size of 12 inches or larger. The display panel 42 includes the display surface 41 on the front side. The display panel 42 includes a pair of surface glass substrates that enclose a liquid crystal layer. Transparent electrodes made of indium tin oxide (ITO) or the like are formed on the pair of glass substrates. The display panel 42 also includes a pair of surface polarizing plates (polarizing filters) disposed to sandwich the pair of surface glass substrates.

The display panel 42 is connected to the circuit board 50 via flexible printed circuits (FPCs) not illustrated. The display panel 42 is controlled by a control portion 53 described later such that a driving voltage is applied to the liquid crystal layer via the transparent electrodes. Applying driving voltage enables control of the orientation of the liquid crystal molecules in the liquid crystal layer to change the transmittance of each pixel of the display panel 42, which allows the display panel 42 to display an image.

The backlight unit 43 is provided rearward of the display panel 42. The backlight unit 43 includes a light source board and a light guide, and illuminates the display panel 42 from behind. A plurality of light emitting diodes (LEDs), which are an example of a light source, are mounted on the light source board. The light source board is connected to the circuit board 50 via a flexible board such as FPC. When a driving current is supplied to the LED, the LED emits light toward the light guide. The light guide guides the light emitted by the LEDs toward the display panel 42. The light guide is formed into a flat plate and is made of a transparent resin (for example, PMMA).

The circuit board 50 is formed in a substantially rectangular shape, and is, for example, a flat rigid circuit board made of an epoxy resin, on which a copper foil pattern is formed based on a predetermined electric circuit. The circuit board 50 is located between and supported by the facing 20 supporting, indirectly via the intermediate inner case 30, a front surface 51 on the display panel 42 side, and the lower case 60 supporting a back surface 52. The circuit board 50 includes a control portion 53, electronic elements (not illustrated), and a light source for the design portion 71 on the front surface 51, and electronic elements, connectors (not illustrated), and the like on the back surface 52.

The control portion 53 includes a central processing unit (CPU), a read only memory (ROM), a random access memory (RAM), a graphics display controller (GDC), etc., and executes predetermined arithmetic processing according to a program written in the ROM, for example. The CPU, ROM, RAM, and GDC include integrated circuit (IC) chips, and generate heat due to power consumption. The control portion 53 acquires various information or the like from, for example, an electronic control unit (ECU) of the vehicle via various sensors or the like. The control portion 53 causes the display unit 40 to display information based on the acquired information.

The light sources for the design portions 71 include LEDs, three of which are disposed on the left of the display unit 40 and other three of which are disposed on the right of the display unit 40. The light sources illuminate the design portions 71 of the indication plate 70. The connector penetrates the lower case 60 and is exposed, and is connected to a cable (not illustrated) extending from the vehicle to receive various information signals.

The inner case 30 is made of a light-blocking synthetic resin (for example, polypropylene resin) having a white color, for example. The inner case 30 is located between and supported by the facing 20 and the circuit board 50. The inner case 30 covers the outer periphery of the display unit 40. The inner case 30 includes a plurality of tubular lighting chambers each housing the light source for the design portion 71. The indication plate 70 is mounted in front of the lighting chambers of the inner case 30.

The indication plate 70 includes a thin, flat base member made of a light-transmitting synthetic resin (such as polycarbonate), and is disposed between the inner case 30 and the facing 20. The indication plate 70 is formed by printing with various inks, such as light-transmitting, light-blocking, and light-diffusing inks, on the front and back surfaces of the indication plate 70. The indication plate 70 includes the plurality of design portions 71 in the shape of warning lights or the like, which are formed by using knockout printing with a light-blocking ink. The design portion 71 is illuminated from behind by the light source to provide a luminous display.

The lower case 60 is made of a resin (for example, a polypropylene resin) having a white color, for example, and is generally formed in a box shape with an open front end, which is formed by a bottom portion 61 and a side wall portion (an outer wall) 62. The lower case 60 houses the display portion 90 and the cover portion 80 covers the front side of the lower case 60. The lower case 60 includes a step portion 63, an attachment stay (an attachment portion) 64, and a reinforcing portion 65. The bottom portion 61 is formed to face the circuit board 50. The side wall portion 62 is formed to extend forward from the outer periphery of the bottom portion 61 to cover the outer periphery of the display portion 90.

The step portion 63 is formed by recessing inward (toward the circuit board 50), a corner part formed by the bottom portion 61 and the side wall portion 62 to form a single step. The step portion 63 includes a bottom step portion 63a, which is a part of the bottom portion 61 offset inward (toward the opening), and a side wall step portion 63b, which is a part of the side wall portion 62 offset inward. The circuit board 50 is placed in the lower case 60 such that the outer periphery of the circuit board 50 is placed on the bottom step portion 63a.

The attachment stays 64 are formed at three locations in total. In the front view of FIG. 1, one of the attachment stays 64 is formed at the center of the upper part of the side wall portion 62, another one is formed at the lower left part of the side wall portion 62, and the other is formed at the lower right part of the side wall portion 62. Each of the attachment stays 64 is formed in a rectangular shape that protrudes outward from a side wall outer surface 62a of the side wall portion 62. The attachment stay 64 is disposed such that a stay front surface 64b is substantially parallel to the display surface 41 (the stay front surface 64b faces the opening side of the lower case 60 or the front side). The attachment stay 64 includes an attachment hole 64a that is a through hole extending in the normal direction of the stay front surface 64b (a front-rear direction). The attachment stay 64 includes a stay back surface 64c which is opposite to the stay front surface 64b and disposed on the instrument panel 200 of the vehicle. The display device 100 is fixed (installed) to the vehicle by a screw S that is inserted into the attachment hole 64a from the stay front surface 64b and then fixed to the instrument panel 200 of the vehicle.

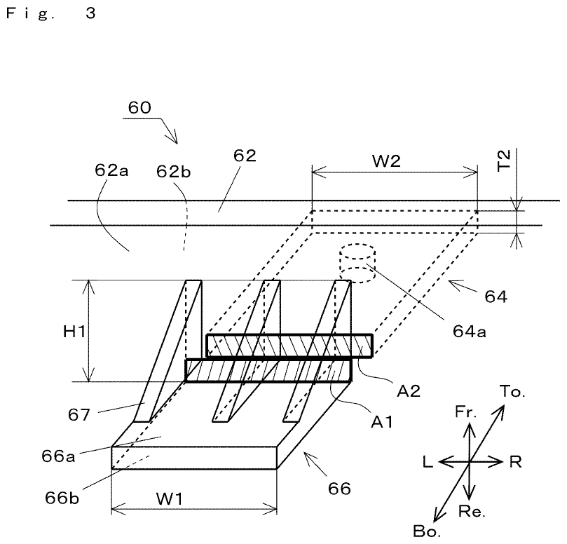

Similarly to the attachment stays 64, the reinforcing portions 65 are formed at three locations in total. One of the reinforcing portions 65 is formed at the center of the upper part of the side wall portion 62, another one is formed at the lower left part of the side wall portion 62, and the other is formed at the lower right part of the side wall portion 62. Each of the reinforcing portions 65 includes a protruding piece 66 and rib portions 67. As illustrated in FIG. 3, the protruding piece 66 is formed in a rectangular shape and protrudes inward (into the interior of the lower case 60) from a side wall inner surface 62b of the side wall portion 62.

The protruding piece 66 protrudes from the side wall portion 62 in a direction opposite to the direction in which the attachment stay 64 protrudes. The protruding piece 66 is disposed such that a piece front surface (a first surface) 66a is substantially parallel to and faces the same direction as the stay front surface 64b. The protruding piece 66 is formed to face the attachment stay 64 (to be opposite to each other) across the side wall portion 62. The protruding piece 66 is formed to have a width W1 equal to or approximately equal to a width W2 of the attachment stay 64.

The protruding piece 66 is also formed to have a thickness T1 equal to or approximately equal to a thickness T2 of the attachment stay 64. A piece contact cross section A1 formed by contact between the protruding piece 66 and the side wall inner surface 62b is a region having the width W1 and the thickness T1. A piece contact cross section A2 formed by contact between the attachment stay 64 and the side wall outer surface 62a is a region having the width W2 and the thickness T2. The piece contact cross section A1 is disposed to almost completely face the piece contact cross section A2 across the side wall portion 62.

The rib portion 67 is formed in a triangular shape having a predetermined width such that the rib portion 67 extends across the side wall inner surface 62b of the side wall portion 62 and the piece front surface 66a of the protruding piece 66. Three rib portions 67 are provided on each of the protruding pieces 66. Two of the rib portions 67 are provided at left and right positions of the piece front surface 66a, respectively, and the other one is provided at a central position between the left and right positions. The rib portion 67 at the central position is formed at a position substantially symmetrical to the attachment hole 64a, with respect to the side wall portion 62, in the normal direction of the side wall portion 62. The rib portions 67 at the left and right positions are formed at the end portions of the protruding pieces 66.

A reinforcement region on the side wall portion 62 is a region defined by a height H1 of the reinforcing portion 65 including the protruding piece 66 and the rib portions 67 and the width W1 of the protruding piece 66. This reinforcement region is disposed to face the piece contact cross section A2 of the attachment stay 64 across the side wall portion 62. This is common to the present embodiment and the following embodiments.

Providing the reinforcing portion 65 at a position such that interference with the instrument panel 200 can be avoided, as described above, improves the strength of the side wall portion 62 on which the attachment stay 64 is provided, also improves the natural frequency of the display device 100 including the attachment stay 64, and thus suppresses breakage of the attachment stay 64. In other words, a sufficient strength of the attachment stay 64 can be ensured without interfering with the instrument panel 200.

### Second Embodiment

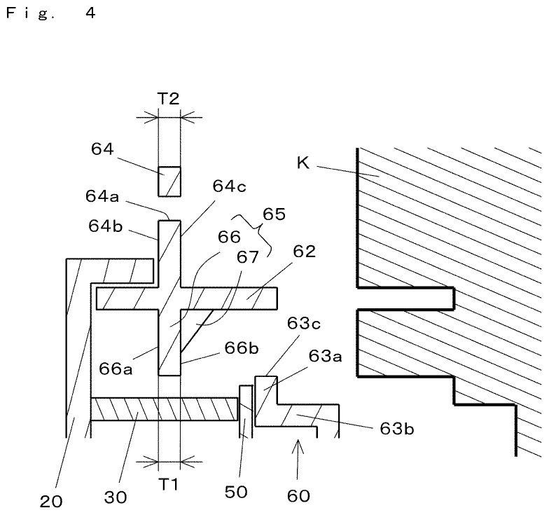

A second embodiment of the display device according to the present disclosure will be described with reference to FIG. 4. In the description, the same reference numerals will be used for the same parts and equivalent parts as those in the above-described first embodiment.

Although in the first embodiment, the rib portion 67 was disposed on the piece front surface 66a side, in the present embodiment, the rib portion 67 is not disposed on the piece front surface 66a side, and is disposed on the piece back surface (a second surface) 66b side opposite the piece front surface 66a. In addition, in the bottom step portion 63a of the lower case 60, a case hole portion 63c is formed in a position facing the protruding piece 66.

Providing the rib portion 67 at such a position can also improve the strength of the side wall portion 62 on which the attachment stay 64 is provided. Note that providing the case hole portion 63c makes it possible to mold the lower case 60 by using two molds K of the front direction and rear direction.

### Third Embodiment

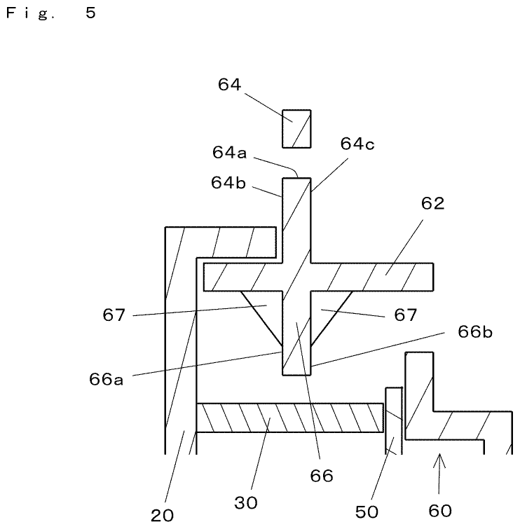

A third embodiment of the display device according to the present disclosure will be described with reference to FIG. 5. In the description, the same reference numerals will be used for the same parts and equivalent parts as those in the above-described first embodiment.

Although in the first embodiment, the rib portion 67 is disposed on the piece front surface 66a side, in the present embodiment, the rib portions 67 are disposed on the piece front surface 66a side and the piece back surface 66b side. As in the second embodiment, in the bottom step portion 63a of the lower case 60, the case hole portion 63c is formed in a position facing the protruding piece 66.

Forming the lower case 60 in this manner can further improve the strength of the side wall portion 62 compared to the first and second embodiments.

### Fourth Embodiment

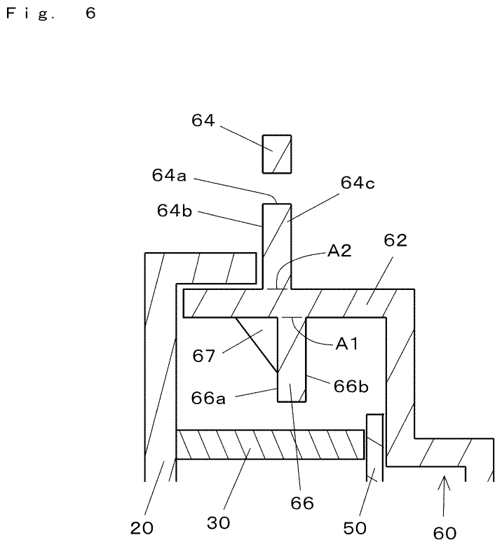

A fourth embodiment of the display device according to the present disclosure will be described with reference to FIG. 6. In the description, the same reference numerals will be used for the same parts and equivalent parts as those in the above-described first embodiment.

Although in the first embodiment, the protruding piece 66 is formed at a position symmetrical to the attachment stay 64 with respect to the side wall portion 62, in the present embodiment, the protruding piece 66 is formed at a position that is slightly offset from the position symmetrical to the attachment stay 64 with respect to the side wall portion 62, toward the bottom portion 61. The piece contact cross section A1 is disposed to face, in part, the piece contact cross section A2 across the side wall portion 62.

Forming the lower case 60 in this manner improves the strength of the side wall portion 62 on which the attachment stay 64 is provided, also improves the natural frequency of the display device 100 including the attachment stay 64, and thus suppresses breakage of the attachment stay 64.

### Fifth Embodiment

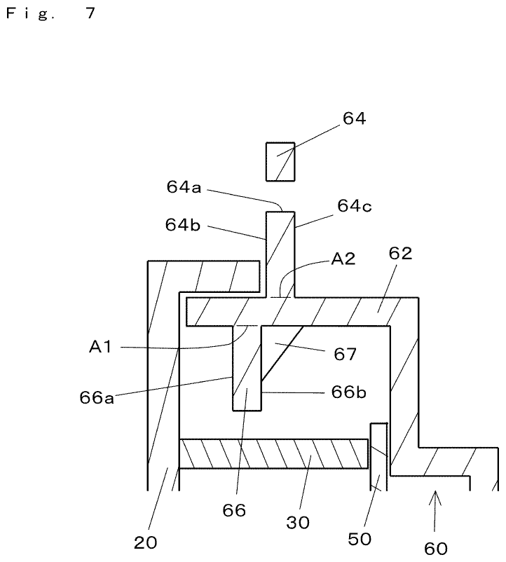

A fifth embodiment of the display device according to the present disclosure will be described with reference to FIG. 7. In the description, the same reference numerals will be used for the same parts and equivalent parts as those in the above-described second embodiment.

Although in the second embodiment, the protruding piece 66 is formed at a position symmetrical to the attachment stay 64 with respect to the side wall portion 62, in the present embodiment, the protruding piece 66 is formed at a position that is slightly offset from the position symmetrical to the attachment stay 64 with respect to the side wall portion 62, toward the opposite side to the bottom portion 61. The piece contact cross section A1 is disposed not to face the piece contact cross section A2 across the side wall portion 62, while the rib portion 67 is disposed in a position facing the piece contact cross section A2 across the side wall portion 62.

Forming the lower case 60 in this manner improves the strength of the side wall portion 62 on which the attachment stay 64 is provided, also improves the natural frequency of the display device 100 including the attachment stay 64, and thus suppresses breakage of the attachment stay 64.

### Sixth Embodiment

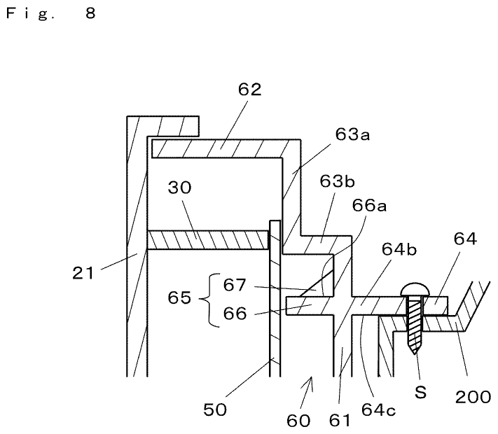

A sixth embodiment of the display device according to the present disclosure will be described with reference to FIG. 8. In the description, the same reference numerals will be used for the same parts and equivalent parts as those in the above-described first embodiment.

Although in the first embodiment, the attachment stays 64 are formed on the side wall portions 62, in the present embodiment, the attachment stays 64 and the reinforcing portions 65 are formed on the bottom portion (the outer wall) 61. The attachment stay 64 is disposed to face upward such that the stay front surface 64b is substantially perpendicular to the display surface 41. The rib portion 67 is formed in a triangular shape having a predetermined width such that the rib portion 67 extends across the bottom portion 61 and the protruding piece 66. The rib portion 67 is disposed on the piece front surface 66a side.

Forming the lower case 60 in this manner improves the strength of the bottom portion 61 on which the attachment stay 64 is provided, also improves the natural frequency of the display device 100 including the attachment stay 64, and thus suppresses breakage of the attachment stay 64.

Although the embodiments of the present invention have been described, these embodiments are merely examples and are not intended to limit the scope of the invention. These novel embodiments can be implemented in various other forms, and various omissions, replacements, and modifications can be made without departing from the spirit of the invention. The embodiments and variations of the embodiments are included in the scope and spirit of the invention, and are also included in the scope of the claimed inventions and equivalents thereof.

In the present disclosure, the display portion 90 displays an image using the display unit 40, but the display portion 90 may include a pointer-type meter having a known structure. The display panel 42 of the display portion 90 may be an organic EL panel.

It is preferable that the width W1 of the protruding piece 66 is equal to or greater than the width W2 of the attachment stay 64. As illustrated in FIG. 4, the thickness T1 of the protruding piece 66 is preferably equal to or greater than the thickness T2 of the attachment stay 64. The number of rib portions 67 may be set appropriately depending on the width of the rib, etc.

### REFERENCE SIGNS LIST

100 . . . Display device
200 . . . Instrument panel
10 . . . Lens
20 . . . Facing
21 . . . Front portion
22 . . . Raised wall portion
23 . . . Display opening portion
24 . . . Indicator opening portion
30 . . . Inner case
40 . . . Display unit
41 . . . Display surface
42 . . . Display panel
43 . . . Backlight unit
50 . . . Circuit board
51 . . . Front surface
52 . . . Back surface
53 . . . Control portion
60 . . . Lower case (case member)
61 . . . Bottom portion
62 . . . Side wall portion
63 . . . Step portion
63a . . . Bottom step portion
63b . . . Side wall step portion
63c . . . Case hole portion
64 . . . Attachment stay (attachment portion)
64a . . . Attachment hole
64b . . . Stay front surface
64c . . . Stay back surface
65 . . . Reinforcing portion
66 . . . Protruding piece
66a . . . Piece front surface
66b . . . Piece back surface
67 . . . Rib portion
70 . . . Indication plate
71 . . . Design portion
80 . . . Cover portion
90 . . . Display portion
K . . . Mold

1. A display device, comprising:
a display portion that displays information; and
a case member housing the display portion,
the case member including an attachment portion protruding outward from an outer wall,
the display device being to be installed in a vehicle by fixing the attachment portion to the vehicle, wherein
the case member includes a reinforcing portion and the reinforcing portion includes a protruding piece protruding inward from the outer wall and a rib portion extending across the outer wall and the protruding piece, and
the reinforcing portion is formed in a position facing the attachment portion.

2. The display device according to claim 1, wherein the rib portion is disposed on a first surface of the protruding piece or on a second surface of the protruding piece opposite to the first surface.

3. The display device according to claim 2, wherein the rib portion is disposed on both the first surface and the second surface.

4. The display device according to claim 1, wherein a reinforcement region of the reinforcing portion is formed by the protruding piece and the rib portion on the outer wall, and is formed in a position facing the attachment portion.

5. The display device according to claim 1, wherein the protruding piece is formed in a position facing the attachment portion.
